(19) United States
(12) Patent Application Publication
(10) Pub. No.: US 2011/0088073 A1
(43) Pub. Date: Apr. 14, 2011

(54) USER-CONFIGURED BACKGROUND CHANNELS IN INTERNET-PROTOCOL TELEVISION

(75) Inventor: Sanjay Macwan, Marlboro, NJ (US)

(73) Assignee: AT&T INTELLECTUAL PROPERTY I, L.P., Reno, NV (US)

(21) Appl. No.: 12/577,625

(22) Filed: Oct. 12, 2009

(51) Int. Cl. H04N 7/173

(52) U.S. Cl. 725/110; 725/131

(57) ABSTRACT

A method and system for implementing background channels includes storing configuration information for a user of a multimedia content distribution network (MCDN). The MCDN user may receive and view a selected channel at an MCDN client. When an exception condition occurs, an indication of a background channel may be displayed to the MCDN user. The configuration information may include user content preferences for matching to metadata in multimedia content to generate the exception condition, as well as an identifier for a desired background channel.

### BACKGROUND

1. Field of the Disclosure

The present disclosure relates to Internet-protocol television (IPTV) and, more particularly, to background channels in IPTV.

2. Description of the Related Art

Users of IPTV services may select from a variety of IPTV channels for viewing. Each channel may display a variety of content.

### BRIEF DESCRIPTION OF THE DRAWINGS

FIG. 1 is a block diagram of selected elements of an embodiment of a multimedia distribution network;

FIG. 2 is a block diagram of selected elements of an embodiment of a multimedia distribution network;

FIG. 3 is a block diagram of selected elements of an embodiment of a multimedia handling device;

FIG. 4 illustrates a block diagram of selected elements of an embodiment of a system for user configuration of background channels; and

FIG. 5 illustrates an embodiment of a method for implementing background channels.

### DESCRIPTION OF THE EMBODIMENT(S)

In one aspect, a disclosed method for implementing background channels over a multimedia content distribution network (MCDN) includes detecting an exception condition while a currently selected multimedia program is displayed at an MCDN client system. The exception condition may be triggered by content included in a background multimedia program. The method also includes determining, via the MCDN, a background channel associated with the background multimedia program, and outputting an indication of the background channel at the MCDN client system. The exception condition may be triggered by a match between configuration information provided by a user of the MCDN client system and content in the background multimedia program, while the user may be associated with an MCDN account. The configuration information may indicate user content preferences corresponding to metadata associated with the multimedia program. The background program content may include metadata indicative of the content, while the exception condition may be triggered in response to a match between the configuration information and the information metadata.

In particular embodiments, the method may further include receiving configuration information for a plurality of MCDN users, associating the exception condition with a matching MCDN user whose configuration information triggered the match, determining a current user of the MCDN client, and outputting the indication only if the current user is the matching MCDN user. The method may further include receiving the indication of the background channel at the MCDN client from an MCDN server. The indication of the background channel may be an audio indication. The indication of the background channel may be a visual indication including at least one of: a textual indication and a video indication. The multimedia program and the indication of the background channel may be output simultaneously. In response to said detecting, the method may further include displaying an indication of the exception condition. Responsive to receiving user input to stop outputting the indication of the background channel, the method may include preventing said outputting. Prior to said detecting, the method may still further include requesting a user confirmation to activate the background channel.

In a further aspect, a disclosed customer premises equipment (CPE) for receiving IPTV channels includes a processor, a network adapter configured to receive multimedia content, a display adapter, and memory media accessible to the processor, including instructions executable by the processor. The processor instructions may be executable to receive, via the network adapter, an IPTV channel selected by a user, detect an exception condition during display of the selected IPTV channel using the display adapter, determine, via the MCDN, a background IPTV channel associated with the exception condition, and output an indication of the background IPTV channel. The CPE may further include processor instructions executable to display the background IPTV channel using the display adapter. The selected IPTV channel and the background IPTV channel may be displayed simultaneously. An audio portion of the background IPTV channel may replace an audio portion of the selected IPTV channel. The indication may be displayed as a picture-in-picture video or a static image overlaying at least a portion of the selected IPTV channel. The exception condition may be triggered by unscheduled events occurring in the multimedia content of the background IPTV channel.

In yet another aspect, a disclosed computer-readable memory media includes executable instructions for providing configurable background IPTV channels. The instructions may be executable to receive an IPTV channel selected by an IPTV user, detect an exception condition during display of the selected IPTV channel, request and receive information indicative of a background IPTV channel associated with the exception condition, and output an indication of the background IPTV channel. The exception condition may be determined from configuration information associated with the IPTV user. In response to receiving an activation input from the IPTV user, the instructions may be executable to activate the background IPTV channel.

In certain embodiments, the memory media may include instructions executable to receive configuration input from the IPTV user associated with the exception condition, including the configuration information. The memory media may further include instructions executable to store the configuration information at an IPTV server.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically or collectively. Thus, for example, widget 12-1 refers to an instance of a widget class, which may be referred to collectively as widgets 12 and any one of which may be referred to generically as a widget 12.

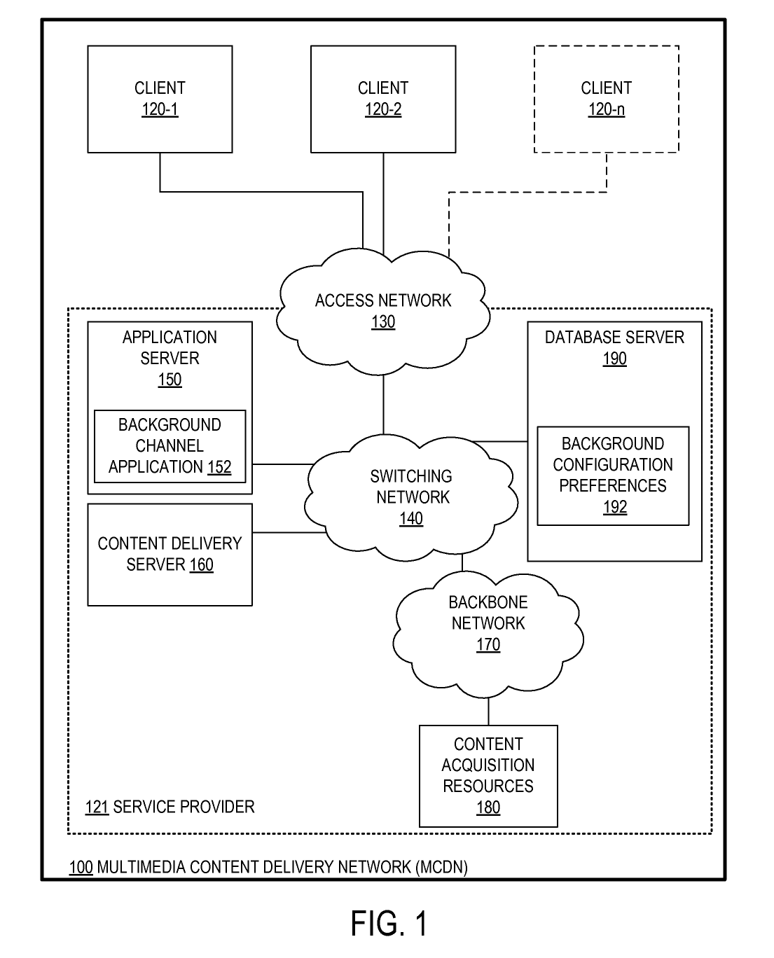

Turning now to the drawings, FIG. 1 is a block diagram illustrating selected elements of an embodiment of MCDN 100. Although multimedia content is not limited to TV, video on demand (VOD), or pay-per-view (PPV) programs, the depicted embodiments of MCDN 100 and its capabilities are primarily described herein with reference to these types of multimedia content, which are interchangeably referred to herein as “multimedia content”, “multimedia content programs”, “multimedia programs” or, simply, “programs.”

The elements of MCDN 100 illustrated in FIG. 1 depict network embodiments with functionality for delivering multimedia content to a set of one or more subscribers. It is noted that different embodiments of MCDN 100 may include additional elements or systems (not shown in FIG. 1 for clarity) as desired for additional functionality, such as data processing systems for billing, content management, customer support, operational support, or other business applications.

As depicted in FIG. 1, MCDN 100 includes one or more clients 120 and a service provider 121. Each client 120 may represent a different subscriber of MCDN 100. In FIG. 1, a plurality of n clients 120 is depicted as client 120-1, client 120-2 to client 120-n, where n may be a large number. Service provider 121 as depicted in FIG. 1 encompasses resources to acquire, process, and deliver programs to clients 120 via access network 130. Such elements in FIG. 1 of service provider 121 include content acquisition resources 180 connected to switching network 140 via backbone network 170, as well as application server 150, database server 190, and content delivery server 160, also shown connected to switching network 140.

Access network 130 demarcates clients 120 and service provider 121, and provides at least one connection path between clients 120 and service provider 121. In some embodiments, access network 130 is an Internet protocol (IP) compliant network. In some embodiments, access network 130 is, at least in part, a coaxial cable network. It is noted that in some embodiments of MCDN 100, access network 130 is owned and/or operated by service provider 121. In other embodiments, a third party may own and/or operate at least a portion of access network 130.

In IP-compliant embodiments of access network 130, access network 130 may include a physical layer of unshielded twisted pair cables, fiber optic cables, or a combination thereof. MCDN 100 may include digital subscriber line (DSL) compliant twisted pair connections between clients 120 and a node (not depicted) in access network 130 while fiber, cable or another broadband medium connects service provider resources to the node. In other embodiments, the broadband cable may extend all the way to clients 120.

As depicted in FIG. 1, switching network 140 provides connectivity for service provider 121, and may be housed in a central office or other facility of service provider 121. Switching network 140 may provide firewall and routing functions to demarcate access network 130 from the resources of service provider 121. In embodiments that employ DSL compliant connections, switching network 140 may include elements of a DSL Access Multiplexer (DSLAM) that multiplexes many subscriber DSLs to backbone network 170.

In FIG. 1, backbone network 170 represents a private network including, as an example, a fiber based network to accommodate high data transfer rates. Content acquisition resources 180 as depicted in FIG. 1 encompass the acquisition of various types of content including broadcast content, other “live” content including national content feeds, and VOD content.

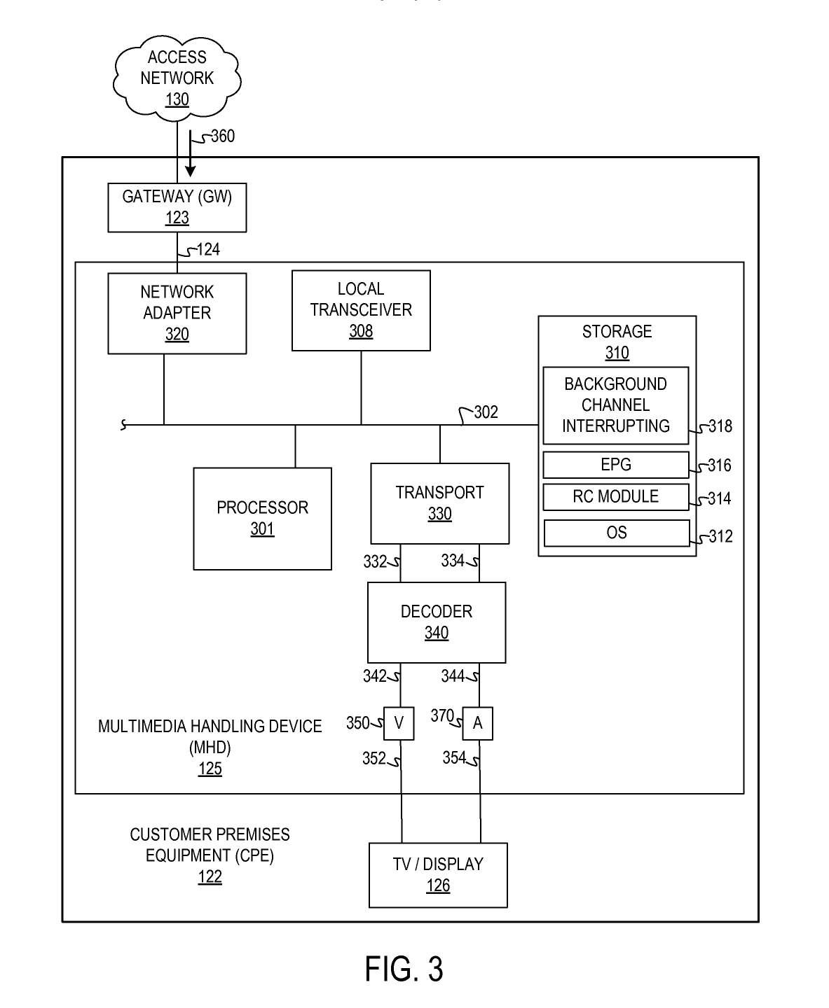

Thus, the content provided by service provider 121 encompasses multimedia content that is scheduled in advance for viewing by clients 120 via access network 130. Such multimedia content, also referred to herein as “scheduled programming,” may be selected using an electronic programming guide (EPG), such as EPG 316 described below with respect to FIG. 3. Accordingly, a user of MCDN 100 may be able to browse scheduled programming well in advance of the broadcast date and time. Some scheduled programs may be “regularly” scheduled programs, which recur at regular intervals or at the same periodic date and time (i.e., daily, weekly, monthly, etc.). Programs which are broadcast at short notice or interrupt scheduled programs are referred to herein as “unscheduled programming.”

Acquired content is provided to content delivery server 160 via backbone network 170 and switching network 140. Content may be delivered from content delivery server 160 to clients 120 via switching network 140 and access network 130. Content may be compressed, encrypted, modulated, demodulated, and otherwise encoded or processed at content acquisition resources 180, content delivery server 160, or both. Although FIG. 1 depicts a single element encompassing acquisition of all content, different types of content may be acquired via different types of acquisition resources. Similarly, although FIG. 1 depicts a single content delivery server 160, different types of content may be delivered by different servers. Moreover, embodiments of MCDN 100 may include content acquisition resources in regional offices that are connected to switching network 140.

Although service provider 121 is depicted in FIG. 1 as having switching network 140 to which content acquisition resources 180, content delivery server 160, and application server 150 are connected, other embodiments may employ different switching networks for each of these functional components and may include additional functional components (not depicted in FIG. 1) including, for example, operational subsystem support (OSS) resources.

FIG. 1 also illustrates application server 150 connected to switching network 140. As suggested by its name, application server 150 may host or otherwise implement one or more applications for MCDN 100. Application server 150 may be any data processing system with associated software that provides applications for clients or users. Application server 150 may provide services including multimedia content services, e.g., EPGs, digital video recording (DVR) services, VOD programs, PPV programs, IPTV portals, digital rights management (DRM) servers, navigation/middleware servers, conditional access systems (CAS), and remote diagnostics, as examples.

Applications provided by application server 150 may be downloaded and hosted on other network resources including, for example, content delivery server 160, switching network 140, and/or on clients 120. Application server 150 is configured with a processor and storage media (not shown in FIG. 1) and is enabled to execute processor instructions, such as those included within a software application. As depicted in FIG. 1, application server 150 may be configured to include background channel application 152, which, as will be described in detail below, is configured to implement user-configured background channels.

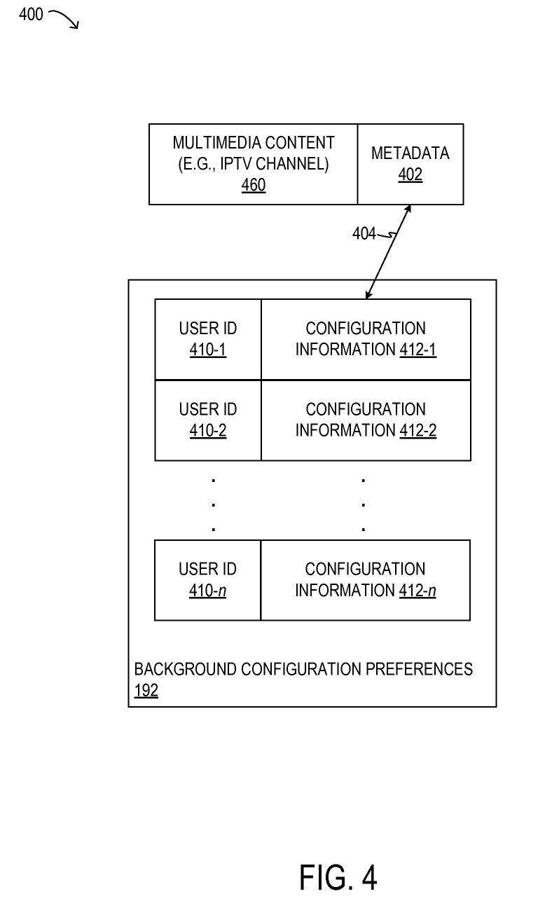

Further depicted in FIG. 1 is database server 190, which provides hardware and software resources for data warehousing. Database server 190 may communicate with other elements of the resources of service provider 121, such as application server 150 or content delivery server 160, in order to store and provide access to large volumes of data, information, or multimedia content. In some embodiments, database server 190 includes a data warehousing application, accessible via switching network 140, that can be used to record and access structured data, such as program or channel metadata for clients 120. Database server 190 is shown including background configuration preferences 192, which may store user configuration information for background channels (see FIG. 4).

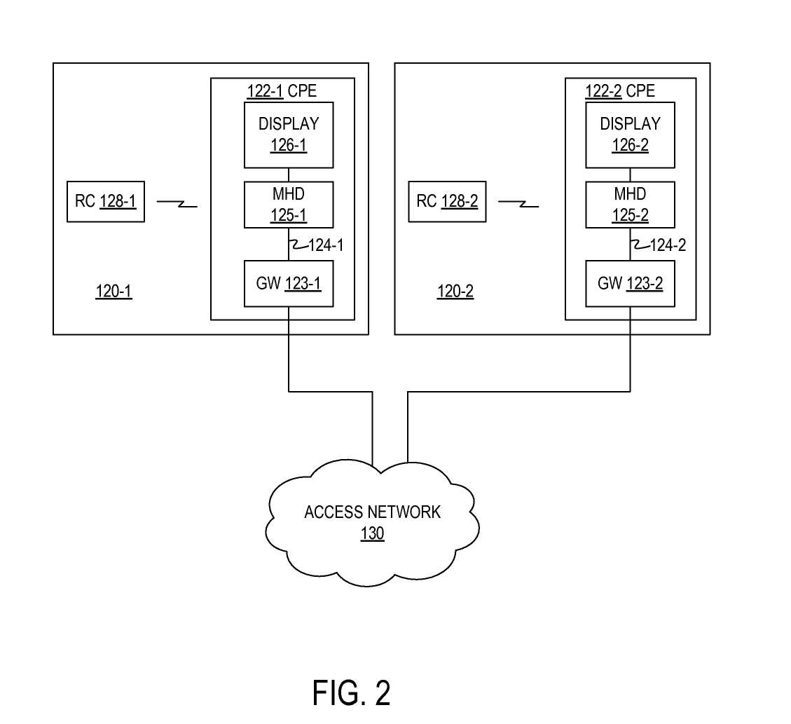

Turning now to FIG. 2, clients 120 are shown in additional detail with respect to access network 130. Clients 120 may include network appliances collectively referred to herein as CPE 122. In the depicted embodiment, CPE 122 includes the following devices: gateway (GW) 123, multimedia handling device (MHD) 125, and display device 126. Any combination of GW 123, MHD 125, and display device 126 may be integrated into a single physical device. Thus, for example, CPE 122 might include a single physical device that integrates GW 123, MHD 125, and display device 126. As another example, MHD 125 may be integrated into display device 126, while GW 123 is housed within a physically separate device.

In FIG. 2, GW 123 provides connectivity for client 120 to access network 130. GW 123 provides an interface and conversion function between access network 130 and client-side local area network (LAN) 124. GW 123 may include elements of a conventional DSL or cable modem. GW 123, in some embodiments, may further include routing functionality for routing multimedia content, conventional data content, or a combination of both in compliance with IP or another network layer protocol. In some embodiments, LAN 124 may encompass or represent an IEEE 802.3 (Ethernet) LAN, an IEEE 802.11-type (WiFi) LAN, or a combination thereof. GW 123 may still further include WiFi or another type of wireless access point to extend LAN 124 to wireless-capable devices in proximity to GW 123. GW 123 may also provide a firewall (not depicted) between clients 120 and access network 130.

Clients 120 as depicted in FIG. 2 further include a display device or, more simply, a display 126. Display 126 may be implemented as a TV, a liquid crystal display screen, a computer monitor, or the like. Display 126 may comply with a display standard such as National Television System Committee (NTSC), Phase Alternating Line (PAL), or another suitable standard. Display 126 may include one or more integrated speakers to play audio content.

Clients 120 are further shown with their respective remote control 128, which is configured to control the operation of MHD 125 by means of a user interface (not shown in FIG. 2) displayed on display 126. Remote control 128 of client 120 is operable to communicate requests or commands wirelessly to MHD 125 using infrared (IR) or radio frequency (RF) signals. MHDs 125 may also receive requests or commands via buttons (not depicted) located on side panels of MHDs 125. In some embodiments, remote control 128 may represent a universal remote control device that is configured to control multiple pieces of equipment.

MHD 125 is enabled and configured to process incoming multimedia signals to produce audio and visual signals suitable for delivery to display 126 and any optional external speakers (not depicted in FIG. 2). Incoming multimedia signals received by MHD 125 may be compressed and/or encrypted, digital or analog, packetized for delivery over packet switched embodiments of access network 130 or modulated for delivery over cable-based access networks. In some embodiments, MHD 125 may be implemented as a stand-alone set top box suitable for use in a coaxial or IP-based multimedia content delivery network.

Referring now to FIG. 3, a block diagram illustrating selected elements of an embodiment of MHD 125 is presented. In FIG. 3, MHD 125 is shown as a functional component of CPE 122 along with GW 123 and display 126, independent of any physical implementation, as discussed above with respect to FIG. 2. In particular, it is noted that CPE 122 may be any combination of GW 123, MHD 125 and display 126.

In the embodiment depicted in FIG. 3, MHD 125 includes processor 301 coupled via shared bus 302 to storage media collectively identified as storage 310. MHD 125, as depicted in FIG. 3, further includes network adapter 320 that interfaces MHD 125 to LAN 124 and through which MHD 125 receives multimedia content 360. GW 123 is shown providing a bridge between access network 130 and LAN 124, and receiving multimedia content 360 from access network 130.

In embodiments suitable for use in IP-based content delivery networks, MHD 125, as depicted in FIG. 3, may include transport unit 330 that assembles the payloads from a sequence or set of network packets into a stream of multimedia content. In coaxial-based access networks, content may be delivered as a stream that is not packet-based and it may not be necessary in these embodiments to include transport unit 330. In a coaxial implementation, however, clients 120 may require tuning resources (not explicitly depicted in FIG. 3) to “filter” desired content from other content that is delivered over the coaxial medium simultaneously and these tuners may be provided in MHDs 125. The stream of multimedia content received by transport unit 330 may include audio information and video information and transport unit 330 may parse or segregate the two to generate video stream 332 and audio stream 334 as shown.

Video and audio streams 332 and 334, as output from transport unit 330, may include audio or video information that is compressed, encrypted, or both. A decoder unit 340 is shown as receiving video and audio streams 332 and 334 and generating native format video and audio streams 342 and 344. Decoder 340 may employ any of various widely distributed video decoding algorithms including any of the Motion Pictures Expert Group (MPEG) standards, or Windows Media Video (WMV) standards including WMV 9, which has been standardized as Video Codec-1 (VC-1) by the Society of Motion Picture and Television Engineers. Similarly decoder 340 may employ any of various audio decoding algorithms including Dolby® Digital, Digital Theatre System (DTS) Coherent Acoustics, and Windows Media Audio (WMA).

The native format video and audio streams 342 and 344 as shown in FIG. 3 may be processed by encoders/digital-to-analog converters (encoders/DACs) 350 and 370 respectively to produce analog video and audio signals 352 and 354 in a format compliant with display 126, which itself may not be a part of MHD 125. Display 126 may comply with NTSC, PAL or any other suitable television standard.

Storage 310 encompasses persistent and volatile media, fixed and removable media, and magnetic and semiconductor media. Storage 310 is operable to store instructions, data, or both. Storage 310 as shown may include sets or sequences of instructions, namely, an operating system 312, a remote control application program identified as RC module 314, and EPG 316, and background channel interrupting 318. Operating system 312 may be a UNIX or UNIX-like operating system, a Windows® family operating system, or another suitable operating system. In some embodiments, storage 310 is configured to store and execute instructions provided as services to client 120 by application server 150, as mentioned previously.

EPG 316 represents a guide to the multimedia content provided to client 120 via MCDN 100, and may be shown to the user as an element of the user interface. The user interface may include a plurality of menu items arranged according to one or more menu layouts, which enable a user to operate MHD 125. The user may operate the user interface, including EPG 316, using remote control 128 (see FIG. 2) in conjunction with RC module 314. In some embodiments, background channel application 152 (see FIG. 1), in conjunction with background channel interruption 318, provides functionality to interrupt a currently selected IPTV channel with an indication of a background channel, as will be described in detail below.

Local transceiver 308 represents an interface of MHD 125 for communicating with external devices, such as remote control 128. Local transceiver 308 may provide a mechanical interface for coupling to an external device, such as a plug, socket, or other proximal adapter. In some cases, local transceiver 308 is a wireless transceiver, configured to send and receive IR or RF or other signals. Local transceiver 308 may be accessed by RC module 314 for providing remote control functionality.

Turning now to FIG. 4, a block diagram of selected elements of an embodiment of MCDN system 400 is depicted. MCDN system 400 illustrates selected devices, interfaces and information that may be processed to implement background channels. In one embodiment, MCDN system 400 represents data processing functionality performed using database server 190 (see FIG. 1).

In FIG. 4, multimedia content 460 may represent any of a number of IPTV channels capable of being received at an MCDN client. Multimedia content 460 is shown with metadata 402, which represents information associated with individual programs in multimedia content 460. Metadata 402 may be information included with multimedia content 460 usable to classify or select content based on certain criteria, such as classification categories. In theory, metadata 402 may be as specific as desired for a given method of classification. For example, metadata 402 may indicate content related to sports in general, or to a specific sport (i.e., football). Metadata 402 may further include an indication of a specific sports team or city (i.e., the Dallas Cowboys). Metadata 402 may further include an indication of a specific player, game, opponent, date, score, and so on. In this manner, metadata 402 may be used to match certain preferences, as indicated in FIG. 4 by match 404 with configuration information 412.

In FIG. 4, background configuration preferences 192 (see also FIG. 1) are shown including a number of entries of configuration information 412 that is indexed to a user ID 410. User ID 410 may represent an identifier for an MCDN user or MCDN user account. In certain embodiments, an MCDN user account is associated with more than one MCDN user, such that background configuration preferences 192 may include different configuration information 412 for different user IDs 410 for an MCDN user account. User ID 410-1 is shown indexed to configuration information 412-1, user ID 410-2 is indexed to configuration information 412-2, and so on up to user ID 410-n indexed to configuration information 412-n. In this manner, n number of entries may be stored in background configuration preferences 192, which may represent a database schema or other structured data storage.

It is noted that configuration information 412 may include various information related to background channels, also referred to herein as “user content preferences.” For example, configuration information 412 may include user content preferences as a list of metadata tags (not shown in FIG. 4) usable to match 404 with metadata 402. An occurrence of match 404 may trigger an exception event while the user is viewing a selected IPTV channel. Configuration information 412 may further include an identifier for the desired background channel (not shown in FIG. 4), such as an IPTV channel identifier. The IPTV channel identifier may be specific to a particular metadata tag, and may be used by the MCDN to obtain a multimedia stream including the identified IPTV channel. Configuration information 412 may further include a desired form of interruption of the background channel, such as textual message, an EPG menu option, a picture-in-picture display, or a static image display. The form of interruption may indicate that an audio portion of the background channel should replace an audio portion of the currently selected IPTV channel. In certain embodiments, the selected IPTV channel and an indication of the background channel are output simultaneously, depending on the user content preferences.

In operation, an MCDN user may enter configuration information 412, for example, via EPG 316 (see FIG. 3). The entered configuration information 412 may include user content preferences for a particular user ID 410. While viewing a selected IPTV channel, the viewer may activate background channel interrupting 318 (see FIG. 3), which may monitor for an exception condition. At some point in time, due to match 404, an exception condition may occur and may be detected by background channel interrupting 318 (see FIG. 3). Background channel interrupting 318 may notify background channel application 152, which may then query background configuration preferences 192 using user ID 410 corresponding to the MCDN user. Background channel application 152 may also query other information from database system 190 for the MCDN user.

In order to determine match 404, metadata 402 for a large number of IPTV channels, represented by multimedia content 460, may be compared to configuration information 412 for a large number of MCDN users. Then, the user IDs 410 corresponding to match 404 may be determined. Based on queried configuration information 412 and match 404, a desired background IPTV channel may be determined and routed to corresponding CPEs 122. An indication of the desired background channel may then interrupt the selected IPTV channel. Such interruption may occur as an overlay message on some portion of the content being displayed on the selected IPTV channel, including the use of a pop-up window or other textual or graphic image. In some embodiments, the overlay message may be partially transparent so as not to block the content being displayed on the selected IPTV channel. The MCDN user may have the option of switching to the background channel or suppressing the indication of the background channel and resuming viewing of the selected IPTV channel, as desired.

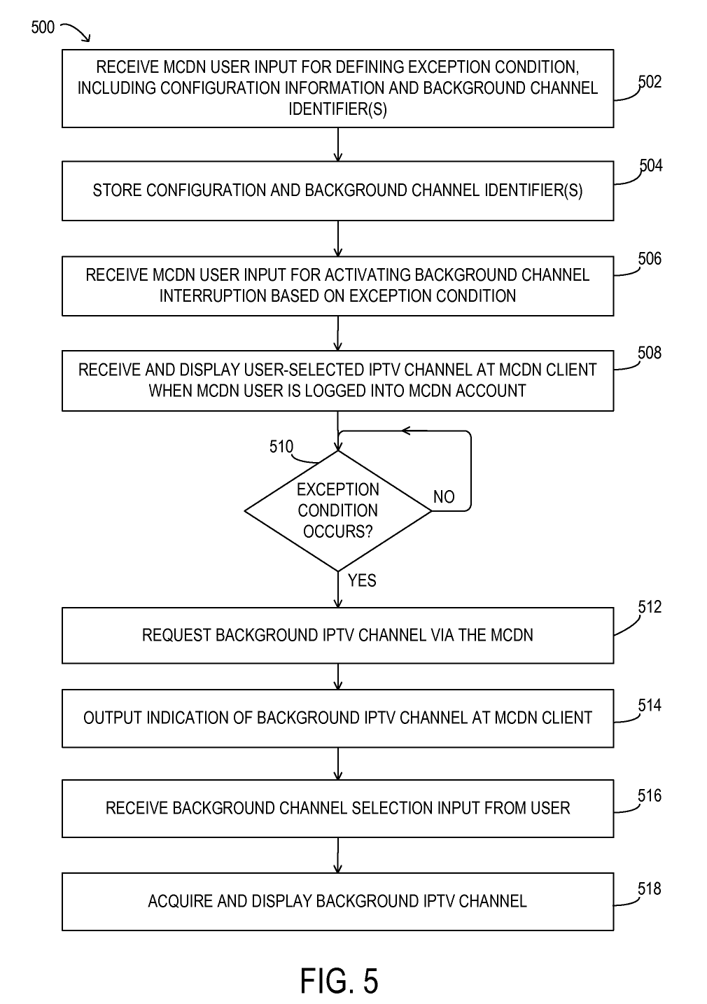

Turning now to FIG. 5, an embodiment of method 500 for implementing background channels is illustrated. In one embodiment, method 500 is performed by background channel application 152 executing on application server 150. Method 500 may also be performed in conjunction with functionality provided by a client device on the MCDN, such as background channel interruption 318 executing on MHD 125 of CPE 122. It is noted that certain operations described in method 500 may be optional or may be rearranged in different embodiments.

Method 500 may begin with receiving MCDN user input for defining an exception condition, including configuration information and background channel identifier(s) (operation 502). The configuration information and background channel identifier(s) may be stored (operation 504). In one embodiment, configuration information 412, along with background channel identifiers, are stored as background configuration preferences 192 indexed to user ID 410 corresponding to an MCDN user account (see FIG. 4). Then, MCDN user input for activating background channel interruption, based on the exception condition, may be received (operation 506). When the MCDN user is logged into the MCDN user account, a user-selected IPTV channel may be received and displayed at the MCDN client (operation 508). The selected IPTV channel may be displayed using CPE 122 (see FIG. 3).

Next, a decision may be made whether an exception condition has occurred (operation 510). If the result of operation 510 is NO, then operation 510 may be repeated. In this manner, method 500 may simply wait until an exception condition occurs. If the result of operation 510 is YES, then an exception condition, as determined by the configuration information, has occurred. In certain embodiments, the exception condition reflects an unplanned, or unscheduled event. For example, in the context of a scheduled sports event, a particular scoring event may be considered an unscheduled event, because there is uncertainty whether or not the scoring event would occur and when it would occur, even though scoring during a sports event is generally expected. Other unscheduled events that could cause an exception condition may include news events, weather events, security events, public service announcements, and political events, among others.

A background IPTV channel may then be requested via the MCDN (operation 512). Streaming of the background IPTV channel to the MCDN client may begin. An indication of the background IPTV channel may be output at the MCDN client (operation 514). The indication may be visual, audio, textual, image, video, or a combination thereof. The indication may be persistent until an action of the user. In other embodiments, absent receipt of user input, the indication may no longer be displayed after a predetermined time period. A background channel selection input may be received from the user (operation 516). The background IPTV channel may be acquired and displayed (operation 518). The background IPTV channel may then replace the selected IPTV channel. The user may also elect not to receive the background IPTV channel so that the selected IPTV channel is not replaced.

To the maximum extent allowed by law, the scope of the present disclosure is to be determined by the broadest permissible interpretation of the following claims and their equivalents, and shall not be restricted or limited to the specific embodiments described in the foregoing detailed description.

What is claimed is:

1. A method for implementing background channels over a multimedia content distribution network (MCDN), comprising:
detecting an exception condition while a currently selected multimedia program is displayed at an MCDN client system, wherein the exception condition is triggered by content included in a background multimedia program;
determining, via the MCDN, a background channel associated with the background multimedia program; and
outputting an indication of the background channel at the MCDN client system.

2. The method of claim 1, wherein the exception condition is triggered by a match between configuration information provided by a user of the MCDN client system and content in the background multimedia program, wherein the user is associated with an MCDN account.

3. The method of claim 2, wherein the configuration information indicates user content preferences corresponding to metadata associated with the multimedia program.

4. The method of claim 2, wherein the background program content includes metadata indicative of the content and wherein the exception condition is triggered in response to a match between the configuration information and the background information metadata.

5. The method of claim 2, further comprising:
receiving configuration information for a plurality of MCDN users;
associating the exception condition with a matching MCDN user whose configuration information triggered the match;
determining a current user of the MCDN client; and
outputting the indication only if the current user is the matching MCDN user.

6. The method of claim 1, wherein said receiving further comprises:
receiving the indication of the background channel at the MCDN client from an MCDN server.

7. The method of claim 1, wherein the indication of the background channel is an audio indication.

8. The method of claim 1, wherein the indication of the background channel is a visual indication including at least one of: a textual indication and a video indication.

9. The method of claim 1, wherein the multimedia program and the indication of the background channel are output simultaneously.

10. The method of claim 1, further comprising:
in response to said detecting, displaying an indication of the exception condition.

11. The method of claim 1, further comprising:
responsive to receiving user input to stop outputting the indication of the background channel, preventing said outputting.

12. The method of claim 1, further comprising:
prior to said detecting, requesting a user confirmation to activate the background channel.

13. A customer premises equipment (CPE) for receiving Internet-protocol television (IPTV) channels, comprising:
a processor;
a network adapter configured to receive multimedia content;
a display adapter; and
memory media accessible to the processor, including instructions executable by the processor to:
receive, via the network adapter, an IPTV channel selected by a user;
detect an exception condition during display of the selected IPTV channel using the display adapter;
determine, via the MCDN, a background IPTV channel associated with the exception condition; and
output an indication of the background IPTV channel.

14. The CPE of claim 13, further comprising processor instructions executable to:
display the background IPTV channel using the display adapter.

15. The CPE of claim 14, wherein the selected IPTV channel and the background IPTV channel are displayed simultaneously.

16. The CPE of claim 14, wherein an audio portion of the background IPTV channel replaces an audio portion of the selected IPTV channel.

17. The CPE of claim 13, wherein the indication is displayed as a picture-in-picture video or a static image overlaying at least a portion of the selected IPTV channel.

18. The CPE of claim 13, wherein the exception condition is triggered by unscheduled events occurring in the multimedia content of the background IPTV channel.

19. Computer-readable memory media, including instructions for providing configurable background Internet-protocol television (IPTV) channels, said instructions executable to:
receive an IPTV channel selected by an IPTV user;
detect an exception condition during display of the selected IPTV channel, wherein the exception condition is determined from configuration information associated with the IPTV user;
request and receive information indicative of a background IPTV channel associated with the exception condition;
output an indication of the background IPTV channel; and
in response to receiving an activation input from the IPTV user, activate the background IPTV channel.

20. The memory media of claim 19, further comprising instructions executable to:
receive configuration input from the IPTV user associated with the exception condition, including the configuration information.

21. The memory media of claim 20, further comprising instructions executable to:
store the configuration information at an IPTV server.
